(19) United States
(12) Patent Application Publication
(10) Pub. No.: US 2024/0320701 A1
(43) Pub. Date: Sep. 26, 2024

(54) WEARABLE DEVICE, INFORMATION PROCESSING METHOD, NON-TRANSITORY COMPUTER READABLE RECORDING MEDIUM STORING INFORMATION PROCESSING PROGRAM, AND INFORMATION PROVIDING SYSTEM

(71) Applicant: Panasonic Intellectual Property Corporation of America, Torrance, CA (US)

(72) Inventors: Kenta MURAKAMI, Osaka (JP); Kotaro SAKATA, Osaka (JP); Minami NAKA, Tokyo (JP)

(21) Appl. No.: 18/736,837

(22) Filed: Jun. 7, 2024

Related U.S. Application Data
(63) Continuation of application No. PCT/JP2022/040521, filed on Oct. 28, 2022.

(30) Foreign Application Priority Data
Dec. 17, 2021 (JP) 2021-205005

(51) Int. Cl. G06Q 30/0207; G06V 20/20

(52) U.S. Cl. CPC G06Q 30/0207; G06V 20/20

(57) ABSTRACT

Smart glasses include a camera, a first control part, a first communication part, and a display part. The camera captures a field of view of a user, the first control part acquires an image captured by the camera and recognizes a first product in a line-of-sight direction of the user from the acquired image with image recognition processing, the first communication part transmits first information about the recognized first product to a product management server and receives second information about a second product related to the first product from the product management server, and the first control part outputs discount information to the display part in a case where the received second information includes the discount information for discounting a price of the second product, and the display part displays the discount information as augmented reality in the field of view of a user.

### FIELD OF INVENTION

The present disclosure relates to a technique of presenting a product to a user.

### BACKGROUND ART

For example, Patent Literature 1 discloses that when a barcode attached to a product is read by a barcode reader after a shopper picks up the product, a suggestion menu using the product having the read product code as an ingredient is searched based on a menu suggestion program and a menu database, a suggestion menu that meets a condition is determined based on inventory information acquired from a POS server, a dish category input by the shopper, an attribute of the shopper, or the like, and information such as a recipe, a shopping list, or a coupon of the suggestion menu is displayed.

However, in the above-described conventional technique, since a shopper has to pick up a product, the product might be unsanitary, and thus further improvement has been required.
Patent Literature 1: JP 2012-168836 A

### SUMMARY OF THE INVENTION

The present disclosure has been made to solve the above problem, and its object is to provide a technique capable of providing product discount information without degrading sanitation of a product.

A wearable device according to the present disclosure is a wearable device worn on a head of a user, the wearable device including a camera, a control part, a communication part, and a display part. The camera captures a field of view of the user, the control part acquires an image captured by the camera and recognizes a first product in a line-of-sight direction of the user from the acquired image with image recognition processing, the communication part transmits first information about the recognized first product to a product management server and receives second information about a second product related to the first product from the product management server, the control part outputs discount information to the display part in a case where the received second information includes the discount information for discounting a price of the second product, and the display part displays the discount information as augmented reality in the field of view of the user.

According to the present disclosure, discount information about a product can be provided without degrading sanitation of the product.

### BRIEF DESCRIPTION OF THE DRAWINGS

FIG. 1 is a diagram illustrating an example of a configuration of an information providing system according to an embodiment of the present disclosure.

FIG. 2 is a diagram illustrating an appearance of smart glasses in the embodiment of the present disclosure.

FIG. 3 is a first flowchart for describing information presentation processing using the smart glasses in the embodiment of the present disclosure.

FIG. 4 is a second flowchart for describing the information presentation processing using the smart glasses in the embodiment of the present disclosure.

FIG. 5 is a diagram illustrating an example of an image captured by a camera when a user shops.

FIG. 6 is a diagram illustrating an example of dish information, ingredient information, and discount information displayed on the display part of the smart glasses in the present embodiment.

FIG. 7 is a diagram illustrating another example of the dish information, the ingredient information, and the discount information displayed on the display part of the smart glasses in the present embodiment.

FIG. 8 is a diagram illustrating an example of guidance information displayed on the display part of the smart glasses in the present embodiment.

FIG. 9 is a diagram illustrating another example of the guidance information displayed on the display part of the smart glasses in the present embodiment.

FIG. 10 is a first flowchart for describing information management processing by a product management server in the embodiment of the present disclosure.

FIG. 11 is a second flowchart for describing the information management processing by the product management server in the embodiment of the present disclosure.

### DETAILED DESCRIPTION

### (Knowledge Underlying Present Disclosure)

In the above-described conventional technique, coupon information is displayed when a barcode attached to a product is read by a barcode reader installed in a shopping cart. Therefore, in order for a user to check the coupon information, the user has to pick up a product and cause the barcode reader to read a barcode attached to the picked-up product. In this case, the user directly touches the product, and the product once touched by the user is returned to a display shelf, so that the product may be unsanitary.

In order to solve the above problem, a technique below is disclosed.

(1) A wearable device according to one aspect of the present disclosure is a wearable device worn on a head of a user, the wearable device including a camera, a control part, a communication part, and a display part. The camera captures a field of view of the user, the control part acquires an image captured by the camera and recognizes a first product in a line-of-sight direction of the user from the acquired image with image recognition processing, the communication part transmits first information about the recognized first product to a product management server and receives second information about a second product related to the first product from the product management server, the control part outputs the discount information to the display part in a case where the received second information includes discount information for discounting a price of the second product, and the display part displays the discount information as augmented reality in the field of view of the user.

According to this configuration, the first product in the line-of-sight direction of the user is recognized by the image recognition processing from the image indicating the field of view of the user captured by the camera. In a case where the second information about the second product related to the recognized first product is received from the product management server and the received second information includes discount information for discounting the price of the second product, the discount information is output to the display part, and the display part displays the discount information in the field of view of the user as augmented reality.

Therefore, since the discount information for discounting the price of the second product related to the first product in the line-of-sight direction of the user is displayed as augmented reality in the field of view of the user without the user touching the first product, the discount information about the product can be provided without degrading the sanitation of the product.

(2) In the wearable device of (1), the first product may be a first ingredient displayed in a shop, and the second product may be a second ingredient used for a dish using the first ingredient.

With this configuration, since the discount information for discounting the price of the second ingredient related to the first ingredient in the line-of-sight direction of the user is displayed as augmented reality in the field of view of the user without the user touching the first ingredient, the discount information about the ingredients can be provided without degrading the sanitation of the ingredients.

(3) In the wearable device of (1), the first product may be a first garment displayed in a shop, and the second product may be a second garment used for coordinates using the first garment.

With this configuration, since the discount information for discounting the price of the second garment related to the first garment in the line-of-sight direction of the user is displayed as augmented reality in the field of view of the user without the user touching the first garment displayed in the shop, the discount information about the garments can be provided without degrading the sanitation of the garments.

(4) In the wearable device described in any one of (1) to (3), the control part may output the discount information to the display part and receive selection by the user as to whether to accept the discount of the price of the second product, and in a case where the user accepts the discount of the price of the second product, output guidance information for guiding from a current position of the user to a position of the second product to the display part based on position information about the second product included in the second information, and the display part may display the guidance information as augmented reality in a field of view of the user.

With this configuration, in a case where the user accepts the discount of the price of the second product, the guidance information for guiding from the current position of the user to the position of the second product is displayed in the field of view of the user as augmented reality, and thus the user can be reliably guided from the current position to the position of the second product.

(5) In the wearable device in (4), the guidance information may include an image indicating a route from the current position of the user to the position of the second product with an arrow.

With this configuration, since the image indicating the route from the current position of the user to the position of the second product with the arrow is displayed as the augmented reality in the field of view of the user, the user can move from the current position to the position of the second product while viewing the image displayed as augmented reality.

(6) In the wearable device in (4), the guidance information may include an image indicating a current position of the user and a position of the second product on a map in a shop where the first product and the second product are displayed.

With this configuration, the image indicating the current position of the user and the position of the second product on the map in the shop where the first product and the second product are displayed is displayed as the augmented reality in the field of view of the user. Therefore, the user can move from the current position to the position of the second product while viewing the image displayed as augmented reality.

(7) In the wearable device described in any one of (1) to (6), in a case where the inventory quantity of the second product in the shop is more than or equal to a predetermined quantity, or in a case where the period from the present to the expiration date of the second product is within a predetermined period, the second information may include the discount information.

With this configuration, in the case where the inventory quantity of the second product is more than or equal to the predetermined quantity in the shop, or in the case where the period from the present to the expiration date of the second product is within the predetermined period, the discount information for discounting the price of the second product is displayed as augmented reality. Therefore, the user can purchase a necessary product at a low price, and the shop can sell a product desired to be sold a lot or a product desired to be sold early.

Further, the present disclosure can be realized not only as the wearable device having the characteristic configuration as described above but also as an information processing method for executing characteristic processing corresponding to the characteristic configuration included in the wearable device. Further, the present disclosure can also be implemented as a computer program that causes a computer to execute characteristic processing included in the information processing method described above. Therefore, also in another aspect described below, the same effect as that of the above-described wearable device can be obtained.

(8) An information processing method according to another aspect of the present disclosure is an information processing method in a wearable device worn on a head of a user, the method including acquiring an image captured by a camera that captures a field of view of the user, recognizing a first product in a line-of-sight direction of the user from the acquired image with image recognition processing, transmitting first information about the recognized first product to a product management server, receiving second information about a second product related to the first product from the product management server, outputting discount information to a display part in a case where the received second information includes the discount information for discounting a price of the second product, and displaying the discount information in the field of view of the user as augmented reality.

(9) An information processing program according to another aspect of the present disclosure causes a computer to perform: acquiring an image captured by a camera that captures a field of view of a user, recognizing a first product in a line-of-sight direction of the user from the acquired image with image recognition processing, transmitting first information about the recognized first product to a product management server, receiving second information about a second product related to the first product from the product management server, outputting discount information to a display part in a case where the received second information includes the discount information for discounting a price of the second product, and displaying the discount information in the field of view of the user as augmented reality.

(10) An information providing system according to another aspect of the present disclosure is an information providing system including a wearable device worn on a head of a user and a product management server that is communicably connected to the wearable device and manages a product in a shop. The wearable device includes a camera, a first control part, a first communication part, and a display part, the product management server includes a second control part, a second communication part, and a memory, the camera captures a field of view of the user, the first control part acquires an image captured by the camera and recognizes a first product in a line-of-sight direction of the user from the acquired image with image recognition processing, the first communication part transmits first information about the recognized first product to the product management server, the second communication part receives the first information transmitted by the first communication part, the memory stores a product combination list indicating combination patterns for using a plurality of products and an inventory product list related to a plurality of products in the shop, the second control part determines a second product related to the first product based on the product combination list, generates discount information for discounting a price of the determined second product based on the inventory product list, and generates second information including the discount information and related to the second product, the second communication part transmits the second information to the wearable device, the first communication part receives the second information transmitted by the second communication part, the first control part outputs the discount information to the display part in a case where the received second information includes the discount information, and the display part displays the discount information as augmented reality in a field of view of the user.

According to this configuration, the first product in the line-of-sight direction of the user is recognized by the image recognition processing from the image indicating the field of view of the user captured by the camera. In a case where the second information about the second product related to the recognized first product is received from the product management server and the received second information includes discount information for discounting the price of the second product, the discount information is output to the display part, and the display part displays the discount information in the field of view of the user as augmented reality.

Therefore, since the discount information for discounting the price of the second product related to the first product in the line-of-sight direction of the user is displayed as augmented reality in the field of view of the user without the user touching the first product, the discount information about the product can be provided without degrading the sanitation of the product.

(11) A non-transitory computer-readable recording medium according to another aspect of the present disclosure that stores an information processing program causes a computer to perform: acquiring an image captured by a camera that captures a field of view of a user, recognizing a first product in a line-of-sight direction of the user from the acquired image with image recognition processing, transmitting first information about the recognized first product to a product management server, receiving second information about a second product related to the first product from the product management server, outputting discount information to a display part in a case where the received second information includes the discount information for discounting a price of the second product, and displaying the discount information in the field of view of the user as augmented reality.

An embodiment of the present disclosure will be described below with reference to the accompanying drawings. The following embodiment is an example in which the present disclosure is embodied, and is not intended to limit the technical scope of the present disclosure.

### Embodiment

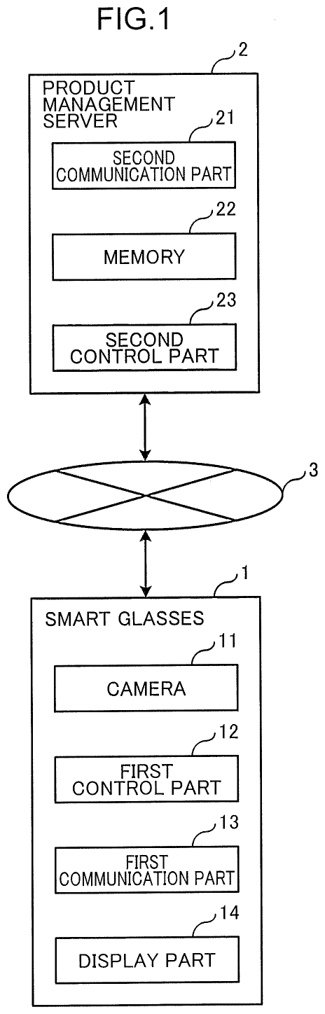

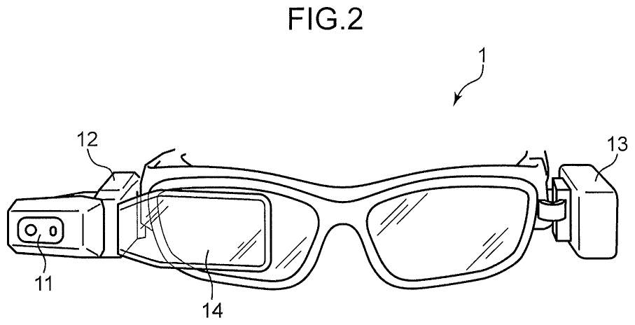

FIG. 1 is a diagram illustrating an example of a configuration of an information providing system according to an embodiment of the present disclosure, and FIG. 2 is a diagram illustrating an appearance of smart glasses 1 in the embodiment of the present disclosure. The information providing system illustrated in FIG. 1 includes the smart glasses 1 and a product management server 2.

The smart glasses 1 are a glasses type wearable device worn on the head of a user. Here, the user is a shopper who purchases a product at a shop. The product is, for example, an ingredient used for dish. The user wears the smart glasses 1 and shops. The smart glasses 1 are communicably connected to the product management server 2 via a network 3. The network 3 is the Internet, for example.

The smart glasses 1 illustrated in FIGS. 1 and 2 include a camera 11, a first control part 12, a first communication part 13, and a display part 14. The first control part 12 is an example of a control part, and the first communication part 13 is an example of a communication part.

The camera 11 captures a field of view of the user. The camera 11 is disposed on the right side of a main body of the smart glasses 1, and captures a view in front of the user wearing the smart glasses 1. An angle of view and a focal length of the camera 11 are set to be substantially equal to a field of view of the user. For this reason, an image acquired by the camera 11 is substantially equal to scenery the user sees with naked eyes. The camera 11 outputs a captured image to the first control part 12.

The first control part 12 is, for example, a central processing unit (CPU), and controls the entire smart glasses 1. The first control part 12 acquires an image captured by the camera 11. The first control part 12 recognizes a first product in a line-of-sight direction of the user from the acquired image by image recognition processing. The first product is a first ingredient displayed in a shop. The first control part 12 recognizes the ingredient at the central portion of the acquired image as the first ingredient in the line-of-sight direction of the user. The first control part 12 acquires an ingredient ID for identifying the first ingredient by reading a barcode attached to a surface of the first ingredient or a package of the first ingredient, and generates first information including the ingredient ID of the first ingredient. Note that the first control part 12 may recognize an ingredient name of the first ingredient from a shape and color instead of reading a barcode.

The first communication part 13 transmits the first information about the first ingredient recognized by the first control part 12 to the product management server 2. Further, the first communication part 13 receives, from the product management server 2, second information about a dish using the first ingredient and a second ingredient related to the first ingredient. The second ingredient is an ingredient used for the dish using the first ingredient.

In a case where the second information received by the first communication part 13 includes discount information for discounting a price of the second ingredient, the first control part 12 outputs the discount information to the display part 14. The first control part 12 outputs the discount information to the display part 14 and receives selection by the user as to whether to accept a discount of the price of the second ingredient. In a case where the user accepts the discount of the price of the second ingredient, the first control part 12 outputs, to the display part 14, guidance information for guiding from a current position of the user to a position of the second product based on the position information about the second ingredient included in the second information. The guidance information includes an image indicating a route from the current position of the user to the position of the second ingredient with an arrow.

The display part 14 is a light transmissive display, and displays various information as augmented reality in a field of view of the user. The display part 14 displays the discount information in the field of view of the user as augmented reality. The display part 14 displays the guidance information in the field of view of the user as augmented reality. For example, the display part 14 displays the discount information or the guidance information in front of the right eye of the user wearing the smart glasses 1.

The product management server 2 is communicably connected to the smart glasses 1, and manages information about products in a shop, information about dishes using products, and the like. The product is, for example, an ingredient used for dish. The product management server 2 may manage products in a plurality of shops or may manage products in one shop.

The product management server 2 includes a second communication part 21, a memory 22, and a second control part 23.

The memory 22 is a storage device, such as a random access memory (RAM), a hard disk drive (HDD), a solid state drive (SSD), or a flash memory, capable of storing various types of information. The memory 22 stores a dish list indicating dishes using a plurality of ingredients, an inventory ingredient list regarding a plurality of ingredients in a shop, and a purchase scheduled ingredient list regarding ingredients put in a basket in a shop by a user who is a shopper. The dish list is an example of a product combination list indicating combination patterns using a plurality of products, and the inventory ingredient list is an example of an inventory product list related to a plurality of products in the shop.

The dish list is a database where dish names and ingredients used for the dishes are associated with each other. For example, a dish name “curry” is associated with carrots, onions, potatoes, meat, curry roux, and the like. Note that the dish list may further include an association with cooking methods.

The inventory ingredient list is a database where an ingredient ID for identifying an ingredient, price information indicating the price of the ingredient, inventory quantity information indicating the inventory quantity of the ingredient, expiration date information indicating the expiration date of the ingredient, and position information indicating the position of the ingredient in a shop are associated with each other. Note that the inventory ingredient list may further include an association with a shop ID for identifying a shop.

The purchase scheduled ingredient list is a database where smart glasses ID for identifying the smart glasses 1 used by the user, an ingredient ID of a purchase scheduled ingredient put in a basket by the user during shopping, and discount information about a discount of a price of the ingredient accepted by the user are associated with each other. The discount information indicates, for example, a discount rate or a discount price of the ingredient.

The second communication part 21 receives the first information transmitted by the first communication part 13 of the smart glasses 1.

The second control part 23 is, for example, a CPU, and controls the entire product management server 2. The second control part 23 determines a second ingredient associated with the first ingredient based on the dish list stored in the memory 22. At this time, first, the second control part 23 determines a dish to be presented to the user from the dish list, the dish using the first ingredient. Next, the second control part 23 determines an ingredient other than the first ingredient to be used for the determined dish as the second ingredient.

Note that, as a procedure where the second control part 23 determines the second ingredient (second product), the second control part 23 may preferentially determine an ingredient (product) in the inventory ingredient list (inventory product list) as the second ingredient (second product) in the dish list (product combination list). Further, in a case where a plurality of candidates for the second ingredient exists, for example, the second control part 23 may give priority to an ingredient (product) that is desired to be sold out quickly in the inventory ingredient list (inventory product list), and determine the second ingredient (second product) based on the priority.

Furthermore, in a case where there is a plurality of ingredients that is other than the first ingredient and is used for the determined dish, the second control part 23 may determine, as the second ingredient, an ingredient of which a period from the present to the expiration date is within a predetermined period or an ingredient of which the inventory quantity in a shop is more than or equal to a predetermined quantity, among the plurality of ingredients.

In addition, in a case where a plurality of dishes using the first ingredient exists, the second control part 23 may extract all ingredients other than the first ingredient used in the plurality of dishes, specify an ingredient whose period from the present to the expiration date is within a predetermined period or an ingredient whose inventory quantity in the shop is more than or equal to a predetermined quantity among all the extracted ingredients, and determine a dish using the specified ingredient as a dish to be presented to the user.

Further, in a case where a plurality of dishes using the first ingredient is present, the second control part 23 may extract all ingredients other than the first ingredient used in the plurality of dishes, and determine, as a dish to be presented to the user, a dish using ingredients that have been already recognized among all the extracted ingredients and has been picked up and put into a basket by the user and the first ingredient.

Furthermore, in a case where a plurality of dishes using the first ingredient is present, the second control part 23 may refer to the inventory ingredient list stored in the memory 22, specify an ingredient of which a period from the present to the expiration date is within a predetermined period or an ingredient of which the inventory quantity of in a shop is greater than or equal to a predetermined quantity among the ingredients other than the first ingredient, and determine a dish using the specified ingredient and the first ingredient as a dish to be presented to the user.

In addition, the second control part 23 generates discount information for discounting the price of the determined second ingredient, based on the inventory ingredient list stored in the memory 22. At this time, the second control part 23 acquires the determined expiration date and inventory quantity of the second ingredient from the inventory ingredient list, and generates discount information for discounting the price of the second ingredient in a case where the period from the present to the expiration date is within a predetermined period or in a case where the inventory quantity in the shop is greater than or equal to a predetermined quantity.

That is, the second control part 23 determines whether the period from the present to the expiration date of the second ingredient is within a predetermined period. In a case where the period from the present to the expiration date of the second ingredient is within the predetermined period, the second control part 23 generates the discount information for discounting the price of the second ingredient. In addition, in a case where the period from the present to the expiration date of the second ingredient is longer than the predetermined period, the second control part 23 determines whether the inventory quantity of the second ingredient in the shop is greater than or equal to a predetermined quantity. In a case where the inventory quantity of the second ingredient in the shop is greater than or equal to the predetermined quantity, the second control part 23 generates the discount information for discounting the price of the second ingredient. In a case where the inventory quantity of the second ingredient in the shop is less than the predetermined quantity, the second control part 23 generates no discount information for discounting the price of the second ingredient.

In this manner, the discount information is not necessarily generated for the determined second ingredient. In a case where the period from the present to the expiration date is longer than the predetermined period or in a case where the inventory quantity in the shop is less than the predetermined quantity, the second control part 23 may not generate the discount information for discounting the price of the second ingredient.

Note that the second control part 23 may generate the discount information for discounting the price of the second ingredient in a case where the period from the present to the expiration date of the second ingredient is within the predetermined period and the inventory quantity of the second ingredient in the shop is greater than or equal to a predetermined quantity.

The discount information may be a discount rate with respect to the price of the second ingredient, or may be a discount price with respect to the price of the second ingredient. In addition, the second control part 23 may generate a predetermined discount rate or a predetermined discount price as the discount information. Further, the second control part 23 may increase the discount rate or the discount price as the period from the present to the expiration date of the second ingredient is shorter. Furthermore, the second control part 23 may increase the discount rate or the discount price as the inventory quantity of the second ingredient is greater.

The second control part 23 generates second information about the second ingredient, including dish information, ingredient information, and discount information. The dish information is information indicating a dish to be presented to the user, the dish using the first ingredient and the second ingredient determined by the second control part 23. The ingredient information is information indicating the second ingredient. Note that the second control part 23 generates the second information including the dish information, the ingredient information, and the discount information in a case where the discount information is generated, and generates the second information that does not include the discount information but includes the dish information and the ingredient information in a case where no discount information is generated. In a case where the inventory quantity of the second ingredient in a shop is greater than or equal to a predetermined quantity or in a case where the period from the present to the expiration date of the second ingredient is within a predetermined period, the second information includes discount information.

The second communication part 21 transmits the second information generated by the second control part 23 to the smart glasses 1.

Note that, in a case where the second information received by the first communication part 13 includes discount information, the first control part 12 of the smart glasses 1 outputs the dish information, the ingredient information, and the discount information to the display part 14. In this case, the display part 14 displays the dish information, the ingredient information, and the discount information as augmented reality. In a case where the second information received by the first communication part 13 includes no discount information, the first control part 12 outputs the dish information and the ingredient information to the display part 14. In this case, the display part 14 displays the dish information and the ingredient information as augmented reality.

Subsequently, information presentation processing by the smart glasses 1 in the embodiment of the present disclosure will be described.

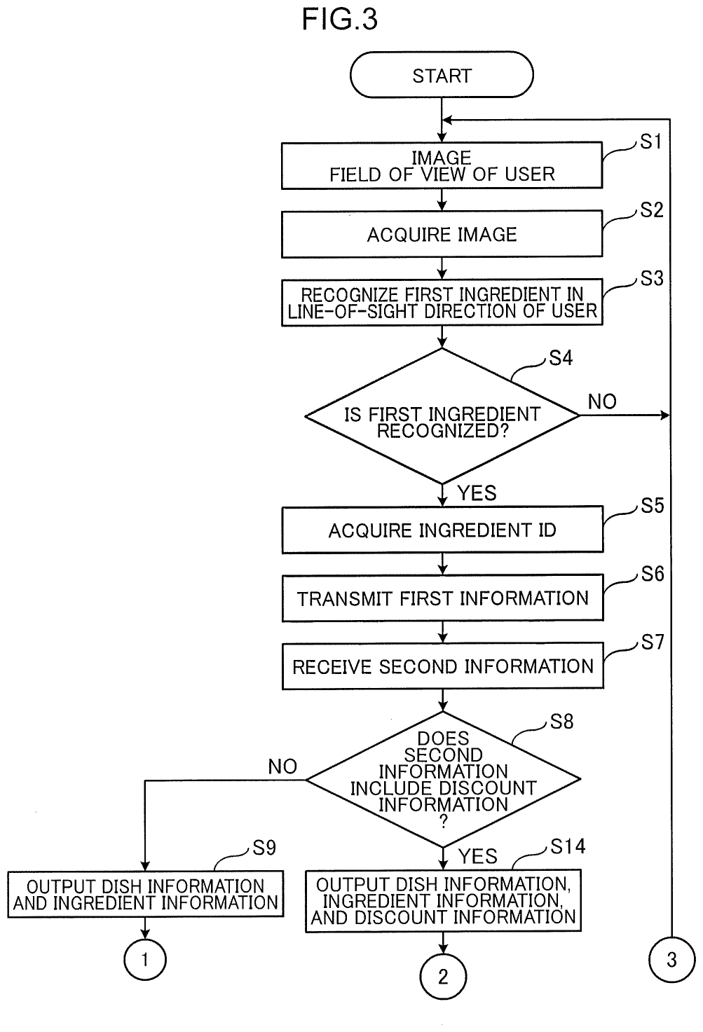

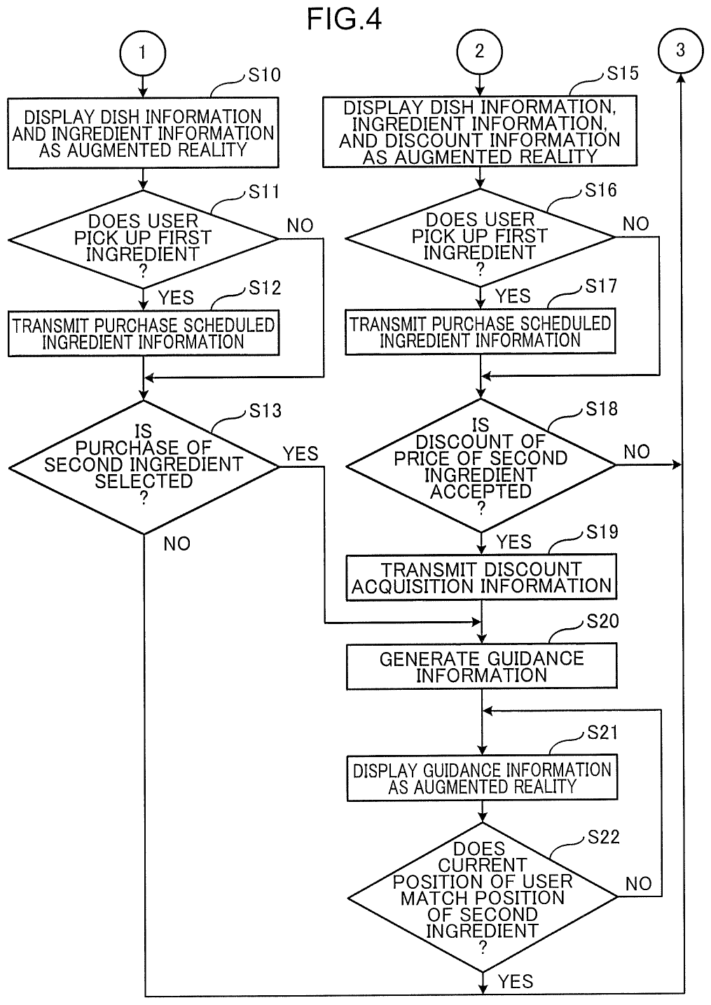

FIG. 3 is a first flowchart for describing the information presentation processing by the smart glasses 1 in the embodiment of the present disclosure, and FIG. 4 is a second flowchart for describing the information presentation processing by the smart glasses 1 in the embodiment of the present disclosure.

First, in step S1, the camera 11 images a field of view of the user. When entering a shop, the user wears the smart glasses 1 and shops. While the user is shopping in the shop, the camera 11 continuously images a field of view of the user.

Next, in step S2, the first control part 12 acquires an image obtained by the camera 11 imaging the field of view of the user from the camera 11.

Next, in step S3, the first control part 12 recognizes a first ingredient in a line-of-sight direction of the user from the acquired image with image recognition processing.

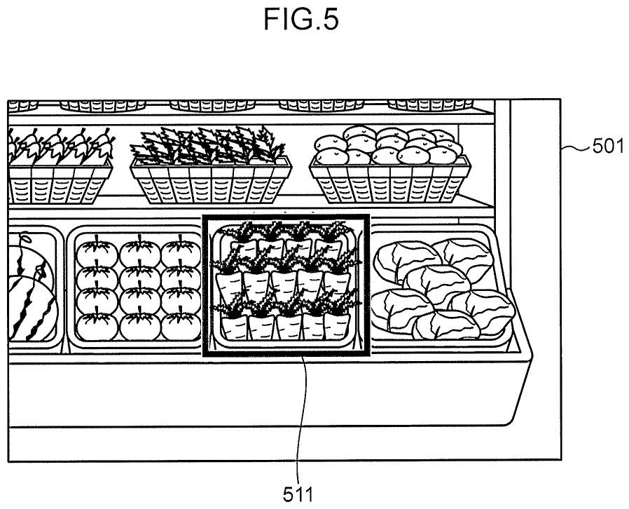

FIG. 5 is a diagram illustrating an example of an image captured by the camera 11 when a user is shopping.

The user pays attention to displayed ingredients when shopping. At this time, the ingredient in the line-of-sight direction of the user exists at the central portion of an image 501 captured by the camera 11. The first control part 12 recognizes the ingredient at the central portion of the acquired image as the first ingredient in the line-of-sight direction of the user. In FIG. 5, the first ingredients recognized from the image 501 are indicated by a rectangular frame line 511. The first ingredients illustrated in FIG. 5 are carrots.

Note that the smart glasses 1 may further include a line-of-sight direction detection part that detects a line-of-sight direction of the user. The first control part 12 may recognize the first ingredients in the line-of-sight direction of the user in the image captured by the camera 11, based on the line-of-sight direction detected by the line-of-sight direction detection part.

Further, the first control part 12 may recognize the user's finger included in the acquired image, recognize the extension direction of the tip of the recognized finger, and recognize, based on the recognized extension direction of the tip of the finger, the first ingredient in the line-of-sight direction of the user in the image captured by the camera 11.

Returning to FIG. 3, next, in step S4, the first control part 12 determines whether to recognize the first ingredient at the central portion of the image. Here, in a case where a determination is made that the first ingredient is not recognized (NO in step S4), the processing returns to step S1.

On the other hand, in a case where the determination is made that the first ingredient is recognized (YES in step S4), in step S5, the first control part 12 reading a barcode attached to the surface of the recognized first ingredient or a package of the first ingredient to acquire an ingredient ID of the first ingredient.

Note that, in a case where the barcode attached to the first ingredient cannot be read, the first control part 12 may acquire the ingredient ID of the first ingredient from the shape and color of the recognized first ingredient. The first control part 12 may perform the image recognition processing using an image recognition model machine-trained so as to recognize the ingredient ID from the image obtained by cutting out the recognized first ingredient. The first control part 12 may input the image obtained by cutting out the recognized first ingredient to the machine-trained image recognition model and acquire a recognition result from the image recognition model. The recognition result indicates the ingredient ID or the ingredient name of the first ingredient on the image.

Note that examples of machine learning include supervised learning in which a relationship between input and output is learned using training data in which a label (output information) is assigned to input information, unsupervised learning in which a data structure is constructed only by unlabeled input, semi-supervised learning in which both labeled and unlabeled input are handled, and reinforcement learning in which an action that maximizes a reward is learned by trial and error. Further, specific methods of machine learning include a neural network (including deep learning using a multilayer neural network), genetic programming, a decision tree, a Bayesian network, and a support vector machine (SVM). In machine learning of an image recognition model, any of the specific examples described above is preferably used.

Further, the first control part 12 may recognize an ingredient ID from an image obtained by cutting out the recognized first ingredient with pattern matching.

Next, in step S6, the first communication part 13 transmits the first information including the ingredient ID of the first ingredient recognized by the first control part 12 to the product management server 2.

Next, in step S7, the first communication part 13 receives the second information transmitted by the product management server 2. Upon receiving the first information transmitted by the smart glasses 1, the product management server 2 generates second information about the second ingredient used for the dish using the first ingredient, and transmits the generated second information to the smart glasses 1. In a case where the discount information about the second ingredient is generated, the second information includes dish information indicating a dish using the first ingredient and the second ingredient, ingredient information indicating the second ingredient, and discount information for discounting the price of the second ingredient. Further, in a case where the discount information about the second ingredient has not been generated, the second information includes dish information indicating the dish using the first ingredient and the second ingredient, and ingredient information indicating the second ingredient.

Next, in step S8, the first control part 12 determines whether the second information received by the first communication part 13 includes discount information. Here in a case where a determination is made that the second information includes no discount information (NO in step S8), in step S9, the first control part 12 outputs the dish information and the ingredient information to display part 14.

Next, in step S10 of FIG. 4, the display part 14 displays the dish information and ingredient information as augmented reality. At this time, the display part 14 displays a message image presenting a dish name and presenting the second ingredient as augmented reality. For example, in a case where the first ingredient is carrot, the second ingredient is potato, and the dish name is curry, the display part 14 displays a message image “Is today's menu curry? How about potato?” as augmented reality. Further, the display part 14 further displays, as augmented reality, a purchase selection image for accepting selection by a user as to whether to purchase the second ingredient. For example, in a case where the second ingredient is potato, the display part 14 displays, as augmented reality, a purchase selection image including a message “Do you purchase potato?”, a first button image for selecting purchase of the second ingredient, and a second button image for rejecting the purchase of the second ingredient.

Next, in step S11, the first control part 12 determines whether the user has picked up a first ingredient. In a case where the user purchases the first ingredient, the user picks up the first ingredient and puts the picked-up first ingredient into a basket. Therefore, if it is found that the user has picked up the first ingredient, it is found that the user intends to purchase the first ingredient. At this time, the first control part 12 recognizes a hand of the user and the first ingredient from the acquired image, and determines whether the user has picked up the first ingredient, based on a positional relationship between the recognized hand and the first ingredient. The first control part 12 may perform the image recognition processing using an image recognition model machine-trained so as to recognize whether the user has picked up the first ingredient from the acquired image. The first control part 12 inputs the acquired image to the machine-learned image recognition model, and obtains a recognition result from the image recognition model. The recognition result indicates whether the user has picked up the first ingredient.

Here, in a case where a determination is made that the user has not picked up the first ingredient (NO in step S11), the processing proceeds to step S13. Note that, in step S11, in a case where the user has not picked up the first ingredient within a predetermined time, the first control part 12 may determine that the user has not picked up the first ingredient.

On the other hand, in a case where a determination is made that the user has picked up the first ingredient (YES in step S11), in step S12, the first communication part 13 transmits purchase scheduled ingredient information indicating that the user intends to purchase the first ingredient to the product management server 2. The purchase schedule ingredient information includes a smart glasses ID for identifying the smart glasses 1 and information (ingredient ID or ingredient name) indicating the first ingredient.

Next, in step S13, the first control part 12 determines whether the user has selected the purchase of the second ingredient. The first control part 12 accepts the selection by the user as to whether to purchase the second ingredient in the purchase selection image. In a case where the user desires to purchase the second ingredient, the user puts a finger on the first button image of the purchase selection image displayed as augmented reality on the display part 14. Further, in a case where the user does not desire to purchase the second ingredient, the user puts a finger on the second button image of the purchase selection image displayed as augmented reality on the display part 14. The first control part 12 recognizes a position where the first button image and the second button image of the purchase selection image are displayed on the image captured by the camera 11. The first control part 12 recognizes the user's finger from the image captured by the camera 11, and determines which one of the first button image and the second button image is selected by the user's finger.

Note that, in a case where the smart glasses 1 further include a line-of-sight direction detection part that detects the line-of-sight direction of the user, the first control part 12 may determine which of the first button image and the second button image matches the line-of-sight direction detected by the line-of-sight direction detection part, and determine which of the first button image and the second button image has been selected by the user.

In addition, the smart glasses 1 may further include an eyelid detection part that detects motion of eyelids of both eyes of the user. In this case, in a case where the first control part 12 determines that the eyelid detection part detects that the eyelid of the right eye has been closed a predetermined number of times (for example, twice) or more, the first control part may determine that the user has selected the first button image, and in a case where determining that the eyelid detection part detects that the eyelid of the left eye has been closed a predetermined number of times (for example, twice) or more, the first control part may determine that the user has selected the second button image.

Further, the first control part 12 may recognize motion of a hand of a user from the image captured by the camera 11. In this case, when recognizing a positive motion of the hand of the user, the first control part 12 may determine that the user has selected the first button image, and when recognizing a negative motion of the hand of the user, may determine that the user has selected the second button image. The positive hand motion is, for example, a motion such that the user makes a circle shape with fingers of both hands or one hand. The negative hand motion is, for example, a motion such that the user makes an X shape with fingers of both hands or a motion such that the user swings one hand from side to side.

In addition, the smart glasses 1 may further include a motion detection part that detects motion of a user's head in a vertical direction (tilt direction) and detects motion of the user's head in a horizontal direction (panning direction). In this case, when the motion detection part detects the vertical motion of the head of the user a predetermined number of times (for example, twice) or more, the first control part 12 may determine that the user has selected the first button image, and when the motion detection part detects the motion of the head of the user in the horizontal direction a predetermined number of times (for example, twice) or more, may determine that the user has selected the second button image.

Further, the smart glasses 1 may include a first button for accepting input of a positive answer from the user and a second button for accepting input of a negative answer from the user. For example, the first button may be disposed on the right side of the frame of the smart glasses 1, and the second button may be disposed on the left side of the frame of the smart glasses 1. In this case, the first control part 12 may determine that the user has selected the first button image when the user presses the first button, and may determine that the user has selected the second button image when the user presses the second button.

Here, in a case where a determination is made that the user has not selected purchase of the second ingredient (NO in step S13), the processing returns to step S1 of FIG. 3.

On the other hand, when a determination is made that the user has selected the purchase of the second ingredient (YES in step S13), the process proceeds to step S20.

Returning to FIG. 3, in a case where the determination is determined in step S8 that the second information includes the discount information (YES in step S8), in step S14, the first control part 12 outputs dish information, ingredient information, and the discount information to the display part 14.

Next, in step S15 of FIG. 4, the display part 14 displays the dish information, and ingredient information, and the discount information as augmented reality. At this time, the display part 14 presents a dish name and displays a message image presenting the second ingredient as augmented reality.

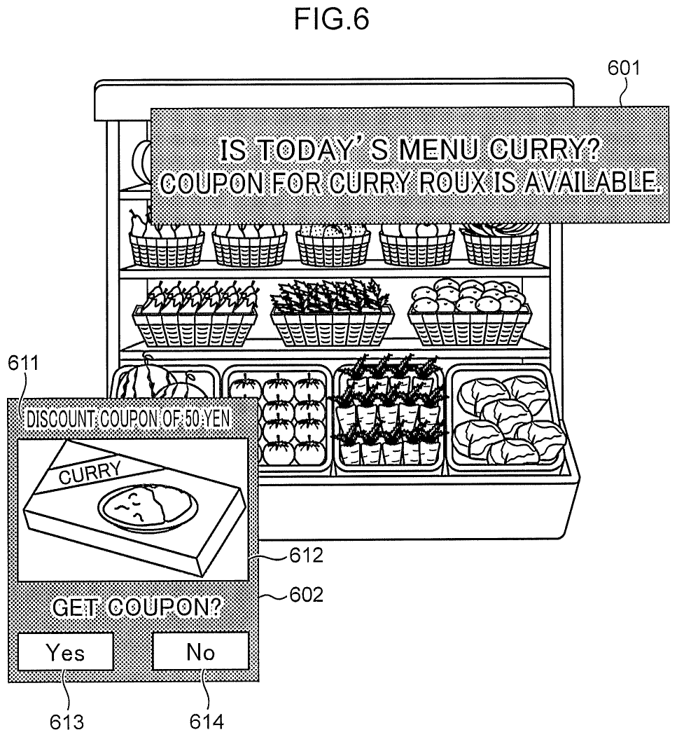

FIG. 6 is a diagram illustrating an example of the dish information, ingredient information, and discount information displayed on the display part 14 of the smart glasses 1 in the present embodiment.

For example, in a case where the first ingredient is carrot, the second ingredient is curry roux, and the dish name is curry, the display part 14 displays a message image 601 representing that “Is today's menu curry? The coupon of the curry roux is available.” as augmented reality. In addition, the display part 14 further displays, as augmented reality, a coupon acquisition selection image 602 for accepting selection by the user as to whether to acquire a coupon for the second ingredient. For example, in a case where the second ingredient is curry roux and the discount information indicates that a discount price of the second ingredient is 50 yen, the display part 14 displays, as augmented reality, a coupon acquisition selection image 602 including messages 611 presenting “50 yen discount coupon” and “Get the coupon?”, an image 612 indicating the appearance of the second ingredient, a first button image 613 for acquiring a coupon for the second ingredient, and a second button image 614 for rejecting acquisition of the coupon for the second ingredient.

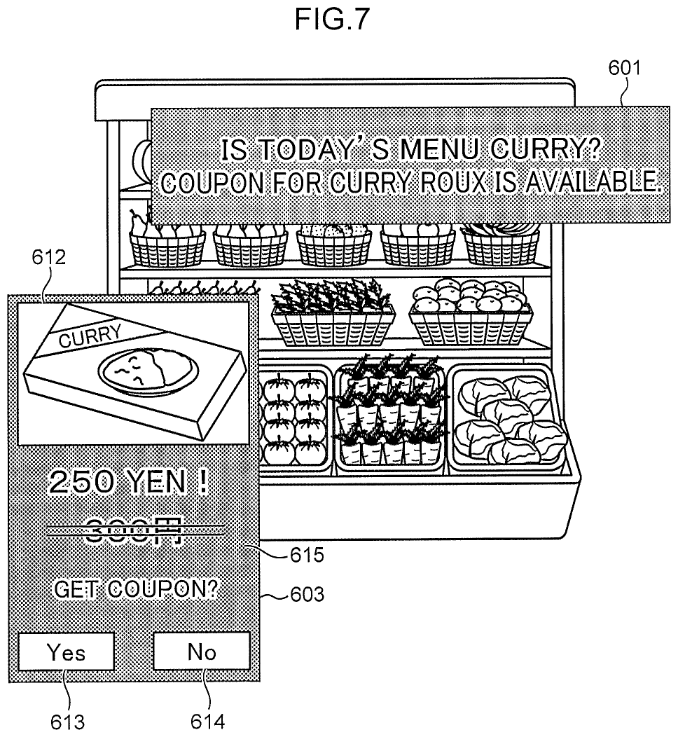

FIG. 7 is a diagram illustrating another example of the dish information, ingredient information, and discount information displayed on the display part 14 of the smart glasses 1 in the present embodiment.

Although the coupon acquisition selection image 602 illustrated in FIG. 6 includes the message 611 indicating the discount price of the second ingredient, the coupon acquisition selection image 603 illustrated in FIG. 7 includes a message 615 indicating the price of the second ingredient before discount and the price of the second ingredient after discount. Strikeout is superimposed on the price of the second ingredient before discount. For example, in a case where the second ingredient is curry roux and the discount information indicates that the discount price of the second ingredient is 50 yen, the display part 14 displays the coupon acquisition selection image 602 including the message 615 indicating “250 yen! Get coupon?”, an image 612, the first button image 613, and the second button image 614 as augmented reality.

Returning to FIG. 4, next, in step S16, the first control part 12 determines whether the user has picked up a first ingredient. Since processing in step S16 is the same as the processing in step S11, description thereof will be omitted.

Here, in a case where a determination is made that the user has not picked up the first ingredient (NO in step S16), the processing proceeds to step S18. Note that, in step S16, in a case where the user has not picked up the first ingredient within a predetermined time, the first control part 12 may determine that the user has not picked up the first ingredient.

On the other hand, in a case where the determination is made that the user has picked up the first ingredient (YES in step S16), in step S17, the first communication part 13 transmits purchase scheduled ingredient information indicating that the user intends to purchase the first ingredient to the product management server 2. The purchase scheduled ingredient information includes a smart glasses ID and information (ingredient ID or ingredient name) indicating the first ingredient picked up by the user.

Next, in step S18, the first control part 12 determines whether the user has accepted discount of the price of the second ingredient. The first control part 12 accepts, on the coupon acquisition selection image 602, selection by the user as to whether to accept the discount of the price of the second ingredient. In a case where the discount of the price of the second ingredient is accepted, the user puts a finger on the first button image 613 of the coupon acquisition selection image 602 displayed as augmented reality on the display part 14. Further, in a case where the discount of the price of the second ingredient is not accepted, the user puts a finger on the second button image 614 of the coupon acquisition selection image 602 displayed as augmented reality on the display part 14. The first control part 12 recognizes a position where the first button image 613 and the second button image 614 of the coupon acquisition selection image 602 are displayed on the image captured by the camera 11. The first control part 12 recognizes the user's finger from the image captured by the camera 11, and determines which one of the first button image 613 and the second button image 614 is selected by the user's finger. Note that the selection of either the first button image 613 or the second button image 614 may be performed by another method described in step S11.

Here, in a case where a determination is made that the discount of the price of the second ingredient has not been accepted by the user (NO in step S18), the processing returns to step S1 of FIG. 3.

On the other hand, in a case where the determination is made that the discount of the price of the second ingredient has been accepted by the user (YES in step S18), in step S19, the first communication part 13 transmits discount acquisition information indicating that the user has accepted the discount of the price of the second ingredient to the product management server 2. The discount acquisition information includes a smart glasses ID for identifying the smart glasses 1 and discount information about the second ingredient. The discount information includes an ingredient ID for identifying a second ingredient to be discounted, and information indicating contents of the discount (a discount rate or a discount price).

Next, in step S20, the first control part 12 generates guidance information for guiding from the current position of the user to a position of the second ingredient. The guidance information includes an arrow image indicating a route from the current position of the user to the position of the second ingredient with an arrow. The memory, not illustrated, of the smart glasses 1 stores a map of a shop in advance. The ingredient information received from the product management server 2 includes the position of the first ingredient in the shop and the position of the second ingredient in the shop. The first control part 12 sets the position of the first ingredient in the shop as the current position of the user, generates the arrow image indicating the route from the current position of the user to the position of the second ingredient with an arrow, and outputs the arrow image to the display part 14.

Next, in step S21, the display part 14 displays the guidance information in a field of view of the user as augmented reality.

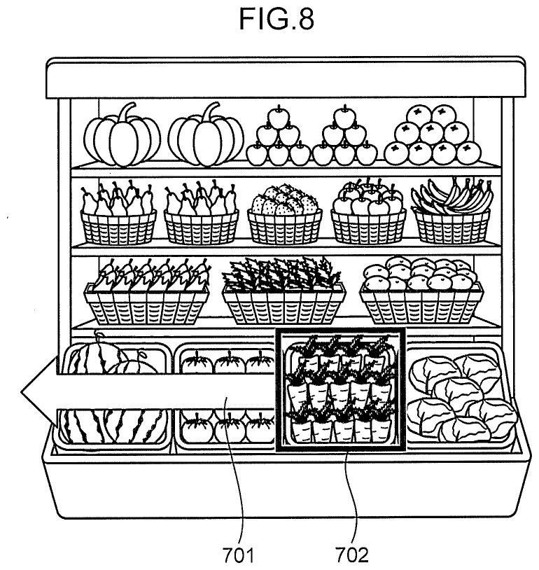

FIG. 8 is a diagram illustrating an example of the guidance information displayed on the display part 14 of the smart glasses 1 in the present embodiment.

The display part 14 displays an arrow image 701 indicating the route from the current position of the user to the position of the second ingredient with an arrow as augmented reality. The arrow image 701 guides the user from the current position of the user to the position of the second ingredient. The user can reach the position where the second ingredient is displayed by the motion in a direction indicated the arrow image 701 displayed on the display part 14. At this time, the first control part 12 may cause the display part 14 to display a frame line 702 surrounding the recognized first ingredient. The smart glasses 1 detect a direction where the front face of the user. Therefore, the first control part 12 causes the display part 14 to change the direction indicated by the arrow of the displayed arrow image 701 in accordance with the motion of the head of the user. Alternatively, the first control part 12 causes the display part 14 to change the direction indicated by the arrow of the displayed arrow image 701 in accordance with the motion of the image captured by the camera 11.

Note that the smart glasses 1 may include a global positioning system (GPS) receiving part that acquires the current position of the smart glasses 1 by receiving a GPS signal transmitted from a GPS satellite. The first control part 12 may use the position of the smart glasses 1 acquired by the GPS receiving part as the current position of the user.

In addition, a plurality of beacon transmitters may be installed in the shop. The smart glasses 1 may include a beacon receiver that receives a signal output from the beacon transmitters, and a memory that stores a map of a shop and installation positions of the plurality of beacon transmitters in the shop in advance. The first control part 12 may specify the current position of the smart glasses 1 in the shop based on the signal received by the beacon receiver. That is, the plurality of beacon transmitters outputs signals including different IDs. The first control part 12 may specify the current position of the smart glasses 1 in the shop based on the ID included in the signal having the greatest strength among the plurality of signals received by the beacon receiver.

Note that together with the arrow image 701, the display part 14 may display, as augmented reality, a time limit from when the arrow image 701 is displayed until the discount of the second ingredient is not accepted. The display part 14 may display the arrow image 701 and the time limit as augmented reality and count down the time limit as time passes. If the second ingredient is recognized in the image recognition processing within the time limit, the discount of the second ingredient is accepted. On the other hand, if the second ingredient is not recognized in the image recognition processing within the time limit, the discount of the second ingredient cannot be accepted. As a result, a game element can be provided to the acceptance of the discount for the second ingredient. In addition, upon expiry of the time limit, the user cannot receive the discount of the second ingredient, but can receive discount information about another second ingredient. Furthermore, the shop can present the discount of the second ingredient to another user.

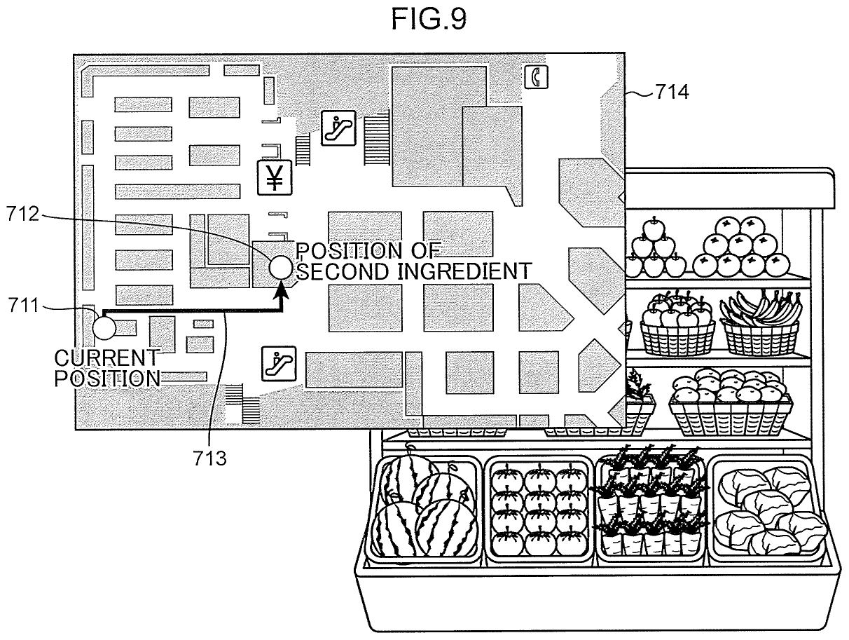

FIG. 9 is a diagram illustrating another example of the guidance information displayed on the display part 14 of the smart glasses 1 in the present embodiment.

The guidance information illustrated in FIG. 8 is the arrow image 701 indicating a route from the current position of the user to the position of the second ingredient with an arrow, but the guidance information illustrated in FIG. 9 is a map image 714 including a current position 711 of the user, a position 712 of the second ingredient, and a guidance route 713 connecting the current position 711 of the user and the position 712 of the second ingredient.

The guidance information may include the map image 714 indicating the current position 711 of the user and the position 712 of the second ingredient on the map in a shop where the first ingredient and the second ingredient are displayed. The display part 14 displays the map image 714 indicating the current position 711 of the user and the position 712 of the second ingredient as augmented reality on the map in the shop. The map image 714 guides the user from the current position of the user to the position of the second ingredient. When the user moves, the current position 711 of the user on the map image 714 also moves. The user can reach the position where the second ingredient is displayed by viewing the map image 714 displayed on the display part 14.

Returning to FIG. 4, next, in step S22, the first control part 12 determines whether the current position of the user matches the position of the second ingredient. When the user arrives at the position of the second ingredient, the current position of the user matches the position of the second ingredient. Here, in a case where a determination is made that the current position of the user does not match the position of the second ingredient (NO in step S22), the processing returns to step S21.

On the other hand, in a case where the determination is made that the current position of the user matches the position of the second ingredient (YES in step S22), the processing returns to step S1 of FIG. 3.

In such a manner, the first product (first ingredient) in the line-of-sight direction of the user is recognized with the image recognition processing from the image indicating the field of view of the user captured by the camera 11. In a case where the second information about the second product (second ingredient) related to the recognized first product (first ingredient) is received from the product management server 2 and the received second information includes discount information for discounting the price of the second product (second ingredient), the discount information is output to the display part 14, and the display part 14 displays the discount information as augmented reality in the field of view of the user.

Therefore, since the discount information for discounting the price of the second product (second ingredient) related to the first product (first ingredient) in the line-of-sight direction of the user is displayed as augmented reality in the field of view of the user without the user touching the first product (first ingredient), the discount information about the product (ingredient) can be provided without degrading the sanitation of the products (ingredients).

Note that, in the present embodiment, in a case where a determination is made that the discount of the price of the second ingredient has been accepted, the discount acquisition information is transmitted to the product management server 2 in step S19, but the present disclosure is not particularly limited thereto. In FIG. 4, in a case where the determination is made that the discount of the price of the second ingredient has been accepted (YES in step S18), after the processing in step S19 is not performed and the processing in step S20 and step S21 is performed, the first control part 12 may determine whether the user has picked up the second ingredient. In a case where a determination is made that the user has picked up the second ingredient, the first communication part 13 may transmit the discount acquisition information to the product management server 2. Then, the processing in step S22 may be performed. On the other hand, in a case where the determination is made that the user has not picked up the second ingredient, the processing in step S22 may be performed without transmitting the discount acquisition information to the product management server 2.

Further, in FIG. 4, the processing in step S18 and step S19 may be deleted, and in step S22, the first control part 12 may determine whether the current position of the user has matched the position of the second ingredient. In a case where a determination is made that the current position of the user has matched the position of the second ingredient, the first communication part 13 may transmit the discount acquisition information to the product management server 2. Alternatively, the first control part 12 may determine whether the user has picked up the second ingredient. In a case where a determination is made that the user has picked up the second ingredient, the first communication part 13 may transmit the discount acquisition information to the product management server 2.

Subsequently, the information presentation processing performed by the product management server 2 in the embodiment of the present disclosure will be described.

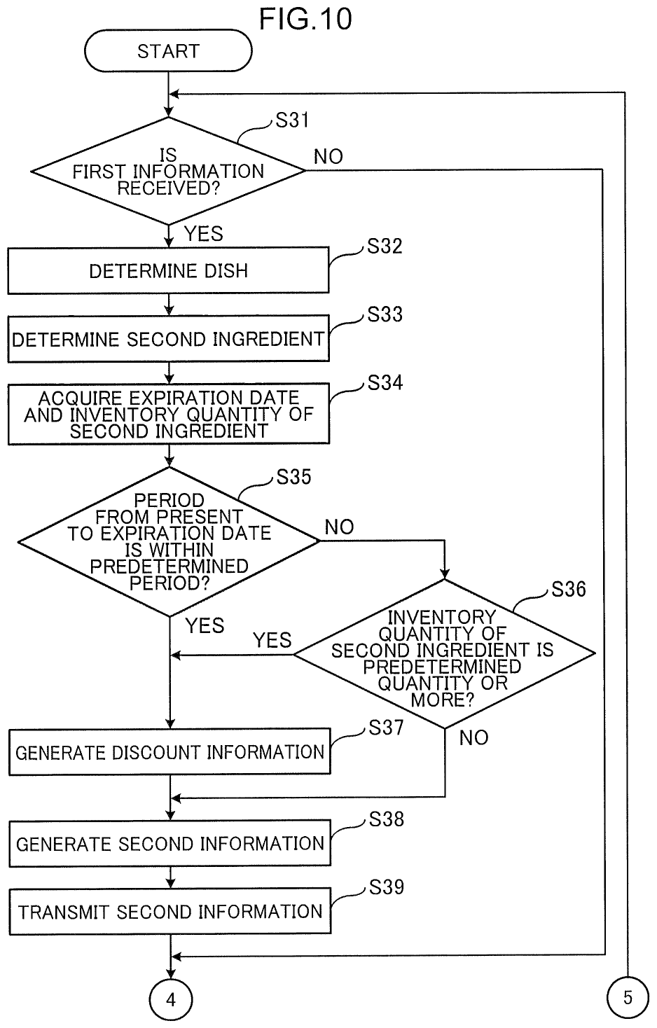

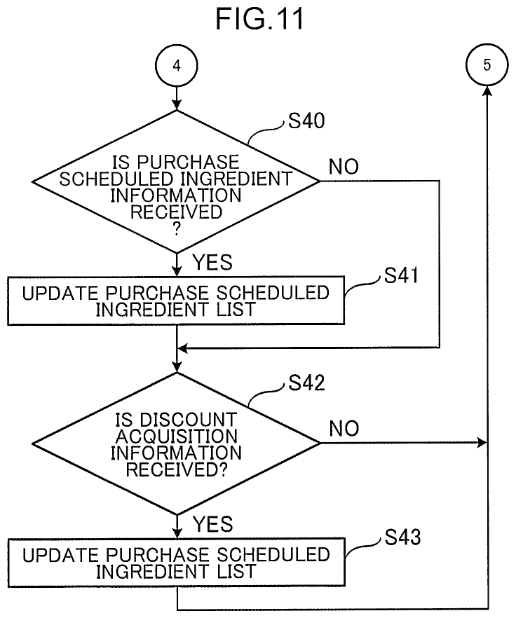

FIG. 10 is a first flowchart for describing the information management processing with the product management server 2 in the embodiment of the present disclosure, and FIG. 11 is a second flowchart for describing the information management processing with the product management server 2 in the embodiment of the present disclosure.

First, in step S31, the second control part 23 determines whether the second communication part 21 receives the first information transmitted by the smart glasses 1. Here, in a case where a determination is made that the second communication part 21 has not received the first information (NO in step S31), the processing proceeds to step S40 in FIG. 11.

On the other hand, in a case where the determination is made that the second communication part 21 has received the first information (YES in step S31), in step S32, the second control part 23 determines a dish to be presented to the user based on the dish list, the dish using the first ingredient. For example, in a case where the first ingredient is carrots, the second control part 23 refers to the dish list stored in the memory 22, and determines curry that is a dish using carrots as the dish to be presented to the user.

Note that the second control part 23 may determine the dish to be presented to the user based on the first ingredient included in the first information and the ingredient registered in the purchase scheduled ingredient list instead of determining the dish to be presented to the user based only on the first ingredient included in the first information. That is, as the user progresses shopping, the number of ingredients registered in the purchase scheduled ingredient list increases. The second control part 23 can further narrow down dishes to be presented to the user by determining the dish using the ingredient registered in the purchase scheduled ingredient list and the first ingredient included in the first information.

Next, in step S33, the second control part 23 determines the second ingredient other than the first ingredient to be used for the determined dish. For example, in a case where the determined dish is curry, the second control part 23 determines, as the second ingredient, curry roux to be used as an ingredient other than carrots in the curry.

Next, in step S34, the second control part 23 acquires the determined expiration date and inventory quantity of the second ingredient from the inventory ingredient list.

Next, in step S35, the second control part 23 determines whether the period from the present to the expiration date of the second ingredient is within a predetermined period.

Here, in a case where a determination is made that the period from the present to the expiration date of the second ingredient is not within the predetermined period, that is, in a case where the determination is made that the period from the present to the expiration date of the second ingredient is longer than the predetermined period (NO in step S35), in step S36, the second control part 23 determines whether the inventory quantity of the second ingredient in the shop is greater than or equal to a predetermined quantity.

Here, in a case where the determination is made that the inventory quantity of the second ingredient in the shop is not greater than or equal to the predetermined quantity, that is, in a case where the determination is made that the inventory quantity of the second ingredient in the shop is less than the predetermined quantity (NO in step S36), the processing proceeds to step S38.

On the other hand, in a case where a determination is made that the period from the present to the expiration date of the second ingredient is within the predetermined period (YES in step S35), or in a case where the determination is made that the inventory quantity of the second ingredient in the shop is greater than or equal to the predetermined quantity (YES in step S36), the second control part 23 generates discount information for discounting the price of the second ingredient in step S37.

Next, in step S38, the second control part 23 generates second information about the second ingredient. At this time, the second control part 23 generates the second information including the dish information, the ingredient information, and the discount information in a case where the discount information is generated, and generates the second information that does not include the discount information but includes the dish information and the ingredient information in a case where no discount information is generated.

Next, in step S39, the second communication part 21 transmits the second information generated by the second control part 23 to the smart glasses 1.

Next, in step S40, the second control part 23 determines whether the second communication part 21 receives the purchase scheduled ingredient information about the first ingredient, the information being transmitted by the smart glasses 1. Here, in a case where a determination is made that the second communication part 21 has not received the purchase scheduled ingredient information (NO in step S40), the processing proceeds to step S42.

On the other hand, in a case where the determination is made that the second communication part 21 has received the purchase scheduled ingredient information (YES in step S40), in step S41, the second control part 23 adds the first ingredient to the purchase scheduled ingredient list stored in the memory 22 by using the purchase scheduled ingredient information about the first ingredient received by the second communication part 21, and updates the purchase scheduled ingredient list. At this time, the second control part 23 stores, in the purchase scheduled ingredient list, information (ingredient ID or ingredient name) indicating the first ingredient picked up by the user included in the purchase scheduled ingredient information in association with the smart glasses ID included in the purchase scheduled ingredient information.

Next, in step S42, the second control part 23 determines whether the second communication part 21 has received the discount acquisition information about the second ingredient, the information being transmitted by the smart glasses 1. Here, in a case where a determination is made that the second communication part 21 has received no discount acquisition information (NO in step S42), the processing returns to step S31 in FIG. 10.

On the other hand, in a case where the determination is made that the second communication part 21 has received the discount acquisition information (YES in step S42), in step S43, the second control part 23 adds the second ingredient to the purchase scheduled ingredient list stored in the memory 22 by using the discount acquisition information about the second ingredient, the information being received by the second communication part 21, and updates the purchase scheduled ingredient list. At this time, the second control part 23 stores, in the purchase scheduled ingredient list, the discount information included in the discount acquisition information in association with the smart glasses ID included in the discount acquisition information. Thereafter, the processing returns to step S31.

Note that, in the present embodiment, the first product is a first ingredient displayed in a shop, and the second product is a second ingredient to be used for a dish using the first ingredient, but the present disclosure is not particularly limited thereto. For example, the first product may be a first garment displayed in a shop, and the second product may be a second garment used for coordinates using the first garment.

Further, in the present embodiment, the information providing system may further include a cash register. The cash register reads barcoded attached to products (ingredients) that are intended to be purchased by a user or accepts an input of prices of the products (ingredients) by a store clerk, thereby summing the prices of all the products (ingredients) that are intended to be purchased by the user. In addition, a barcode indicating a smart glasses ID is affixed to the surface of the smart glasses 1. The cash register reads the barcode attached to the smart glasses 1 to acquire the smart glasses ID. The cash register transmits a discount information request for requesting discount information associated with the smart glasses ID to the product management server 2. The discount information request includes the smart glasses ID. Upon receiving the discount information request, the product management server 2 extracts the discount information associated with the smart glasses ID from the purchase scheduled ingredient list, and transmits the extracted discount information to the cash register. The cash register performs a discount associated with the received discount information on the total price of all products (ingredients) scheduled to be purchased by the user, and calculates a price after the discount. The cash register presents the calculated price and settles the price.

Note that the smart glasses 1 may further include a radio frequency (RF) tag that stores the smart glasses ID, and the cash register may further include a reader and writer that receives the smart glasses ID transmitted from the RF tag of the smart glasses 1.

Further, in the present embodiment, the cash register makes a store clerk to read the barcode attached to a product (ingredient) or accepts input of a price of a product (ingredient) from the store clerk, but the present disclosure is not particularly limited thereto. In a case where the memory 22 of the product management server 2 stores the purchase scheduled ingredient list in which the smart glasses ID, the ingredient IDs of a purchase scheduled ingredient put in a basket by the user during shopping, and the discount information are associated with each other, the cash register may transmit, to the product management server 2, a discount information request for requesting the ingredient ID of the purchase scheduled ingredient associated with the smart glasses ID and the discount information. The discount information request includes the smart glasses ID. Upon receiving the discount information request, the product management server 2 may extract the ingredient ID of the purchase scheduled ingredient and the discount information associated with the smart glasses ID from the purchase scheduled ingredient list, and transmit the extracted ingredient ID and discount information to the cash register. The cash register may calculate the total price of all the ingredients associated with received ingredient IDs, perform a discount corresponding to the received discount information on the calculated total price, and calculate the price after the discount. The cash register may present the calculated price and settle the price.

Further, in the present embodiment, the information providing system may further include an information terminal used by the user. The information terminal is, for example, a smartphone. The information terminal reads a barcode attached to the smart glasses 1 to acquire a smart glasses ID. Then, the information terminal may transmit a user ID stored in advance in the information terminal and the smart glasses ID to the product management server 2. The memory 22 of the product management server 2 may store user information in which a user ID is associated with a purchase history, a hobby, a taste, a health condition, and a shopping tendency (for example, whether to buy a product even if the expiration date is close) of the user. The second control part 23 of the product management server 2 may determine a dish to be presented to the user with reference to a purchase history, hobby, taste, health condition, and shopping tendency of the user.

In addition, the second control part 23 of the product management server 2 may increase the discount rate of the second ingredient when the second ingredient is an ingredient that has been purchased by the user a predetermined number of times or more in the past.

In addition, the second communication part 21 of the product management server 2 may transmit the discount information accepted by the user to the information terminal used by the user. The information terminal may perform a discount using the received discount information when paying the price of a product (ingredient) using an application.

Further, in the present embodiment, the smart glasses 1 determines whether the user has picked up the first ingredient, but the present disclosure is not particularly limited thereto, and may determine whether the user has put the first ingredient in a basket. For example, an RF tag may be attached to an ingredient, and the reader and writer included in the basket may receive the ingredient ID of the first ingredient transmitted from the RF tag. The communication part of the basket may transmit the ingredient ID received by the reader and writer to the smart glasses 1. In a case where the ingredient ID of the first ingredient transmitted by the communication part of the basket is received, the first control part 12 of the smart glasses 1 may determine that the user has put the first ingredient in the basket. On the other hand, in a case where the ingredient ID of the first ingredient is not received even after a predetermined time has elapsed from the recognition of the first ingredient, the first control part 12 may determine that the user has not put the first ingredient in the basket.

In addition, the display part 14 of the smart glasses 1 may display a distance from the current position of the user to the second ingredient together with the guidance information. In this case, a beacon transmitter may be disposed on each of a plurality of product shelves in a shop. The smart glasses 1 may further include a beacon receiver that receives a signal output from the beacon transmitter. The beacon receiver of the smart glasses 1 receives a signal transmitted from the beacon transmitter disposed on a product shelf on which the second ingredient is placed. The first control part 12 may estimate the distance from the current position of the user to the second ingredient based on the strength of the received signal, and display the estimated distance as augmented reality on the display part 14.

Further, a bar code representing a basket ID for recognizing the basket may be affixed to the surface of the basket in which a product (ingredient) is put. At the time of payment for a product (ingredient), the smart glasses 1 may acquire the basket ID by reading the barcode attached to the basket and transmit the acquired basket ID and smart glasses ID to the product management server 2. In addition, the cash register may acquire the basket ID by reading the barcode attached to the basket, and transmit the acquired basket ID to the product management server 2. The second communication part 21 of the product management server 2 may receive the basket ID and the smart glasses ID from the smart glasses 1 and receive the basket ID from the cash register. The second control part 23 may acquire discount information associated with the received smart glasses ID from purchase scheduled ingredient list. The second communication part 21 may transmit the acquired discount information to the cash register that has transmitted the basket ID identical to the basket ID received from the smart glasses 1.

In addition, in the purchase scheduled ingredient list, a basket ID for identifying a basket in which a product (ingredient) is put, a smart glasses ID, an ingredient ID of a purchase scheduled ingredient, and discount information may be associated in advance. In a shop, a basket and smart glasses whose IDs are associated in advance are placed together, and a user wears the smart glasses placed together with the basket. At the time of payment for a product (ingredient), the cash register may acquire the basket ID by reading the barcode attached to the basket, and transmit the acquired basket ID to the product management server 2. The second control part 23 of the product management server 2 may acquire discount information associated with the basket ID and the smart glasses ID from the purchase scheduled ingredient list. The second communication part 21 may transmit the acquired discount information to the cash register that has transmitted the basket ID.

Note that in each of the above embodiments, each constituent may include dedicated hardware or may be implemented by execution of a software program suitable for each constituent. Each constituent element may be implemented by a program execution part, such as a CPU or a processor, reading and executing a software program recorded in a recording medium such as a hard disk or a semiconductor memory. Further, the program may be carried out by another independent computer system by being recorded in a recording medium and transferred or by being transferred via a network.

Some or all functions of the devices according to the embodiments of the present disclosure are implemented as large scale integration (LSI), which is typically an integrated circuit. These functions may be individually integrated into one chip, or may be integrated into one chip so as to include some or all functions. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the devices according to the embodiments of the present disclosure may be implemented by a processor such as a CPU executing a program.

The numerical figures used above are all illustrated to specifically describe the present disclosure, and the present disclosure is not limited to the illustrated numerical figures.

The order in which each step shown in the above flowcharts is executed is for specifically describing the present disclosure, and may be any order other than the above order as long as a similar effect is obtained. Some of the above steps may be executed simultaneously (in parallel) with other steps.

The technique according to the present disclosure is useful as a technique for presenting a product to a user because discount information about a product can be provided without degrading sanitation of a product.

1. A wearable device worn on a head of a user, the wearable device comprising:
a camera;
a control part,
a communication part; and
a display part,
wherein the camera captures a field of view of the user,
wherein the control part acquires an image captured by the camera, and
recognizes a first product in a line-of-sight direction of the user from the acquired image with image recognition processing,
wherein the communication part
transmits first information about the recognized first product to a product management server, and
receives second information about a second product related to the first product from the product management server,
wherein the control part outputs discount information to the display part in a case where the received second information includes the discount information for discounting a price of the second product, and
wherein the display part displays the discount information as augmented reality in the field of view of the user.

2. The wearable device according to claim 1, wherein
the first product is a first ingredient displayed in a shop, and
the second product is a second ingredient used for a dish using the first ingredient.

3. The wearable device according to claim 1, wherein
the first product is a first garment displayed in a shop, and
the second product is a second garment used for coordinates using the first garment.

4. The wearable device according to claim 1,
wherein the control part
outputs the discount information to the display part and accepts selection by the user as to whether to accept discount of the price of the second product, and
outputs, in a case where the user accepts the discount of the price of the second product, guidance information for guiding from a current position of the user to a position of the second product to the display part based on position information about the second product included in the second information, and
wherein the display part displays the guidance information as augmented reality in a field of view of the user.

5. The wearable device according to claim 4, wherein the guidance information includes an image indicating a route from the current position of the user to the position of the second product with an arrow.

6. The wearable device according to claim 4, wherein the guidance information includes an image indicating the current position of the user and the position of the second product on a map in the shop where the first product and the second product are displayed.

7. The wearable device according to claim 1, wherein the second information includes the discount information in a case where an inventory quantity of the second product in the shop is greater than or equal to a predetermined quantity, or in a case where a period from a present to an expiration date of the second product is within a predetermined period.

8. An information processing method in a wearable device worn on a head of a user, the method comprising:
acquiring an image captured by a camera that captures a field of view of the user;
recognizing a first product in a line-of-sight direction of the user from the acquired image with image recognition processing;
transmitting first information about the recognized first product to a product management server;
receiving second information about a second product related to the first product from the product management server; and
outputting discount information to a display part in a case where the received second information includes the discount information for discounting a price of the second product, and displaying the discount information in the field of view of the user as augmented reality.

9. A non-transitory computer readable recording medium storing an information processing program for causing a computer to perform:
acquiring an image captured by a camera that captures a field of view of a user;
recognizing a first product in a line-of-sight direction of the user from the acquired image with image recognition processing;
transmitting first information about the recognized first product to a product management server;
receiving second information about a second product related to the first product from the product management server; and
outputting discount information to a display part in a case where the received second information includes the discount information for discounting a price of the second product, and displaying the discount information in the field of view of the user as augmented reality.

10. An information providing system comprising:
a wearable device worn on a head of a user; and
a product management server that is communicably connected to the wearable device and manages a product in a shop,
wherein the wearable device includes a camera, a first control part, a first communication part, and a display part,
wherein the product management server includes a second control part, a second communication part, and a memory,
wherein the camera captures a field of view of the user,
wherein the first control part
acquires an image captured by the camera and
recognizes a first product in a line-of-sight direction of the user from the acquired image with image recognition processing,
wherein the first communication part transmits first information about the recognized first product to the product management server,
wherein the second communication part receives the first information transmitted by the first communication part,
wherein the memory stores a product combination list indicating combination patterns for using a plurality of products and an inventory product list related to a plurality of products in the shop,
wherein the second control part
determines a second product related to the first product based on the product combination list,
generates discount information for discounting a price of the determined second product, based on the inventory product list, and
generates second information including the discount information and related to the second product,
wherein the second communication part transmits the second information to the wearable device,
wherein the first communication part receives the second information transmitted by the second communication part,
wherein the first control part outputs the discount information to the display part in a case where the received second information includes the discount information, and
wherein the display part displays the discount information as augmented reality in the field of view of the user.
